(19) United States
(12) Patent Application Publication
(10) Pub. No.: US 2026/0139722 A1
(43) Pub. Date: May 21, 2026

(54) EXTRACTABLE DOUBLE-TUBE GAS SPRING

(71) Applicant: NINGBO YILI INDUSTRIAL CO., LTD., Ningbo, Zhejiang (CN)

(72) Inventors: Duanzhong Ying, Beilun, Ningbo City (CN); Libin Wang, Beilun, Ningbo City (CN)

(73) Assignee: Yili Industrial U.S. Co., Ltd., Grand Rapids, MI (US)

(21) Appl. No.: 18/685,742

(22) PCT Filed: Aug. 16, 2023
(86) PCT No.: PCT/CN2023/113223

§ 371 Date: Feb. 22, 2024

(30) Foreign Application Priority Data
Jul. 31, 2023 (CN) 202310957587.4

(51) Int. Cl. F16F 9/02; F16F 9/32; F16F 9/34

(52) U.S. Cl. CPC F16F 9/0245; F16F 9/0281; F16F 9/3214; F16F 9/3221; F16F 9/34; F16F 2222/126

(57) ABSTRACT

The invention discloses an extractable and controllable double-tube gas spring, including an outer steel tube; an inner steel tube, the inner steel tube is slidingly provided with a piston inside the outer steel tube; a hollow piston rod, the rear end of which extends from the front end of the outer steel tube into the inner steel tube; a one-way throttle valve, the front end of which is connected to the hollow piston rod, and a control rod is slidingly provided with the hollow piston rod, and a valve pin is provided inside the one-way throttle valve, and the control rod is mated with the valve pin to control opening and closing of the one-way throttle valve, the one-way throttle valve is sealed and slidingly fitted with the inner wall of the inner steel tube when the hollow piston rod is compressed and the one-way throttle valve controls the throttling. The one-way throttle valve controls the opening and closing of the one-way throttle valve, the one-way throttle valve seals and slides with the inner wall of the inner steel tube, and the one-way throttle valve controls the gas direction and volume when the hollow piston rod is compressed. This solution makes the gas spring employ smooth expansion and contraction and also can employ the downward pressure easily, no jamming, vibration and noise, keep the large locking force.

### CROSS-REFERENCE TO RELATED APPLICATION

This application claims priority under 35 USC § 371 to Chinese PCT Application No. PCT/CN2023/113223, filed on Aug. 16, 2023 which is incorporated herein by reference in its entirety.

### FIELD OF THE DISCLOSURE

The present invention relates to the technical field of gas springs, in particular to an extractable double-tube gas spring.

### BACKGROUND OF THE DISCLOSURE

A gas spring is an industrial accessory that can perform functions such as support, buffering, braking, height adjustment and angle adjustment. It consists of the following parts: a pressure cylinder, a piston rod, a piston, a sealing guide sleeve, a filler (an inert gas or an oil-air mixture), an in-cylinder control element and an out-of-cylinder control element (referring to a controllable gas spring), and a connector, etc. The principle is that the closed pressure cylinder is filled with an inert gas or an oil-gas mixture. The principle is in a closed pressure cylinder filled with inert gas or oil and gas mixture, so that the pressure in the cavity is higher than the atmospheric pressure of a few times or ten times, the use of the piston rod cross-sectional area is smaller than the cross-sectional area of the piston and thus the resulting pressure difference to achieve the movement of the piston rod.

The existing gas spring that can be adjusted for extension and compression has the phenomenon of jamming and vibration during extension and compression, and the internal parts are easy to collide and generate high-decibel noise during rapid extension and compression; at the same time, there exists the problem that the dead (locking) force value under the locking state is low, and the downward pressure is heavy. The existing gas spring is not able to realize the downward pressure easily when it realizes the slow extension and compression, and it is not able to realize the slow extension and compression when it realizes the downward pressure easily.

For example, Chinese Patent Publication No. CN212360610U, Publication Date Jan. 15, 2021, entitled “A light-starting double-tube controllable spring,” describes a gas spring comprising an outer steel tube, said outer steel tube being a cavity structure with front and rear axial penetration, a first rear plug sealing and closing on the rear opening of the outer steel tube, and the front opening of the outer steel tube contracting inwardly to form a blocking surface; further comprising a hollow piston rod with front and rear axial penetration, the rear end of said hollow piston rod sliding and inserting into the inner part of the outer steel tube from the front end of the outer steel tube, and a guide sleeve and a sealing effect guide sleeve being mounted at the inner front position of the outer steel tube for axial support and sealing effect, respectively, guide sleeve for axial support and a bowl-shaped gasket for sealing, respectively.

The existing patents have the disadvantage that the existing gas springs are prone to the problems of jamming, vibration and noise during rapid extension, as well as the problems of lower dead force values and heavier down force in the locked state.

### SUMMARY OF THE DISCLOSURE

The purpose of the present invention is to solve the problems of easy jamming, vibration and noise during rapid extension of existing gas springs, as well as the problems of low dead force value and heavy downward pressure in the locked state, and to provide an extension and retraction controllable double-tube gas spring, which enables the gas spring to realize easy downward pressure even when it is slowly extended and retracted, with no jamming, vibration and noise, and with a large dead force value.

In order to realize the above purposes, the present invention adopts the following technical solution:
An extractable double-tube gas spring, comprising: an outer steel tube; an inner steel tube, the inner steel tube is slidably set inside the outer steel tube by a piston; a hollow piston rod, the rear end of the hollow piston rod extends into the inner steel tube from the front end of the outer steel tube; a one-way throttle valve, the front end of the one-way throttle valve is connected to the hollow piston rod, a control rod is slidably provided inside said hollow piston rod, a valve pin is provided inside said one-way throttle valve, and said control rod is cooperatively controlled by opening and closing the one-way throttle valve, said hollow piston rod is sealed and slidably fitted with the inner wall of the inner steel tube, said hollow piston rod is sealingly fitted with the inner wall of the inner steel tube, and said control rod is sealed and slidably fitted with the pin. said control rod and valve pin, said control rod and valve pin cooperate to control the opening and closing of the one-way throttle valve, said one-way throttle valve is sealed and slidingly cooperated with the inner wall of the inner steel pipe, and the one-way throttle valve controls throttling when the hollow piston rod is compressed. An extractable double tube gas spring described in this program, there is a gas chamber between the outer steel tube and the inner steel tube, and there is an oil chamber between the one-way throttle valve and the inner steel tube, and the control rod adjusts the valve pin to start, realizing the telescoping of the gas spring; withdrawing the external force on the control rod, the valve pin due to the internal and external pressures are different and the external pressure is less than the internal pressure, thus generating a thrust to make the valve pin shut down, at this time the oil circuit is closed, and the oil is more difficult to be compressed, and the internal At this time, the oil circuit is closed, the oil is harder to be compressed, the internal pressure is unchanged, the hollow piston rod can stay in any position, and make the hollow piston rod has a higher value of dead force, better stability, and can withstand a larger external force.

Adopting the double tube structure design of inner steel tube and outer steel tube, the outer steel tube is used for elastic buffer, and the inner steel tube is used for stroke displacement, which makes the friction generated during the gas spring extension process (compression of the hollow piston rod after the valve pin is activated) greatly reduced; the gas spring extends slowly, realizing no jamming and vibration in the stroke extension, and the slow extension avoids noise generated by collision of the internal parts of the gas spring.

A one-way throttle valve is connected to the rear end of the hollow piston rod, and the one-way throttle valve acts as a throttling valve in the gas spring extension process, making the gas spring extension slow; the one-way throttle valve does not act as a throttling valve in the gas spring depressing process, making the gas spring depressing easy. It realizes the performance that the gas spring can be extended slowly and press down easily at the same time.

Preferably, said one-way throttle valve comprises a valve body piston and a throttle valve, said throttle valve is provided at the rear end of said valve body piston, and said valve body piston is sealing and slidingly fitted with the inner wall of the inner steel tube. A sealing ring is provided between said valve body piston and the inner wall of the inner steel tube to provide a sealing effect. Said one-way throttle valve is sealingly slid inside the inner steel tube by the valve body piston.

As a preference, said throttle valve comprises a valve body and a valve plate, said valve body is connected to the rear end of the valve body piston, said valve plate is socketed on the valve body, said valve plate slides axially along the center axis of the valve body, said valve body is provided with a flow channel, said valve plate is provided with a notch at an end facing the flow channel, said notch is cooperated with said flow channel to form a throttling port, and said throttling port throttles the flow in one direction. Said runner passes through the interior of the inner steel tube and the valve body piston, when the hollow piston rod is compressed after the valve pin is activated, the oil in the inner steel tube flows from the throttle valve to the valve body piston, and the oil squeezes the valve piece to move toward the front end of the valve body, and at this time the throttle port is open, and the unidirectional throttle valve does not have a throttling effect, which makes it easy for the gas spring to be pressed down; when the hollow piston rod is stretched out after the valve pin is activated, the oil in the inner steel tube flows from the valve piston to the throttle valve, and the oil squeezes the valve piece to move toward the rear end of the valve body. When the valve pin is activated and the hollow piston rod is extended, the oil inside the inner steel tube flows from the piston of the valve body to the throttle valve, the oil squeezes the valve piece to move towards the back end of the valve body, the valve piece cooperates with the said runner to form the throttling port, and the one-way throttle valve acts as a throttling valve, so as to make the gas spring extend slowly, and to realize the stroke extension without jamming and jitter, and the slow extension avoids the noise generated by the collision of the internal parts of the gas spring.

As a preference, said valve piece includes a non-notched valve piece and a notched valve piece slidingly set on the valve body, said notched valve piece is located at the rear end of the non-notched valve, said notch is located on the notched valve piece, and said notched valve piece and the non-notched valve cooperate with the flow path of the valve body to form a throttling port. Said notched valve piece, notched valve and valve body are coaxially provided, and the structural design of the notched valve piece and notched valve piece cooperating with each other makes it easy to process the valve piece.

Preferably, said valve body includes an axially through valve body and a rivet, said rivet is axially riveted to the valve body, said rivet includes a rivet tube body with an opening toward the valve body piston and a rivet end set at the front end of the rivet tube body, said valve piece is socketed on the rivet tube body, and said rivet end restricts the valve piece on the rivet tube body. Said rivet is provided with an opening toward the valve body piston, and the rivet serves to support the valve body body and limit the valve piece. The number of said runners is a plurality, said runners are distributed circumferentially according to the center axis of the valve body, said front end of said valve body is provided with an annular groove, said annular groove is connected to the runners, the shown annular groove makes the oil pass through the runners and then passes through the throttling holes evenly, and the valve piece is subjected to uniform pressure.

Preferably, said valve body piston is provided with a mounting groove at the rear end of said valve body piston, said front end of said valve body piston is fixedly mounted in said mounting groove, and the interior of said inner steel tube is connected to the valve body piston through a flow channel. Said valve body piston is fixedly seated in the mounting slot.

Preferably, said rivet end rests against the bottom of the slot of the mounting groove, said rivet end is provided with an opening, said opening passing through the interior of the valve body piston and the inner steel tube. Said notch prevents the rivet end from blocking the rear end of the valve body piston, and said valve body piston throttle valve passes through the notch.

Preferably, said opening in the rivet tube body toward the valve body piston is provided coaxially with the valve pin, and when the control rod is compressed, the rear end of the valve pin extends into said opening. Said opening is used to avoid extension and compression of the valve pin.

As a preferred option, said valve body piston is provided with a valve cavity, said valve body piston is provided with an overflow hole on the side wall, said valve body piston is provided with an upper chamber between the front end of the inner steel tube, said valve body piston is provided with a lower chamber between the valve body piston and the throttle port, said overflow hole passes through the upper chamber and the valve cavity, said valve cavity and the lower chamber are realized to be opened and closed by the valve pin, and said lower chamber passes through the interior of the inner steel tube. When the hollow piston rod is compressed after the valve pin is activated, the oil inside the inner steel tube passes through the flow channel, the throttle port, the lower cavity, the valve cavity, the overflow holes and enters into the upper cavity in sequence; when the hollow piston rod is extended after the valve pin is activated, the oil inside the upper cavity passes through the overflow holes, the valve cavity, the lower cavity, the flow channel and enters into the oil cavity in sequence.

Preferably, said valve pin is provided with a seal between said valve pin and the inner wall of the piston valve body, said mounting groove is provided with a limit groove at the bottom of said groove, said limit groove is provided with a shim, said shim to limit the seal within the valve cavity, said valve pin passes through said shim, and said shim has a conical front-smaller back-smaller inside wall toward one end of the throttle valve. Said gasket is used to limit a limit ring in the valve cavity, said gasket being seated in said limit slot. The conical surface on said gasket cooperates with the valve pin so that the cross-sectional change of the oil as it passes through the lower chamber is small, reducing the phenomenon of turbulence of the oil.

Thus, the present invention has the following beneficial effects:
(1) The hollow piston rod can stay at any position, and the hollow piston rod has a higher dead force value and better stability, and can withstand larger external forces;
(2) The double tube structure design of inner steel tube and outer steel tube is adopted, the outer steel tube is used for elastic buffer, the inner steel tube is used for stroke displacement, which makes the friction generated in the process of gas spring extension greatly reduced; the gas spring extends slowly to realize the stroke extension without jamming and jitter, and the slow extension avoids the noise generated by collision of the internal parts of the gas spring;
(3) The rear end of the hollow piston rod is connected to the one-way throttle valve, the one-way throttle valve plays a throttling role in the process of gas spring extension, which makes the gas spring extend slowly; the one-way throttle valve does not play a throttling role in the process of gas spring lowering, which makes the gas spring lowering easy; to realize that the gas spring extension is slow and at the same time, the performance of lowering is easy to be realized.

### BRIEF DESCRIPTION OF THE DRAWINGS

FIG. 1 is a sectional view of a double-tube gas spring in accordance with the present invention.

FIG. 2 is a sectional view of the hollow piston rod and one-way throttle connection of the gas spring of FIG. 1.

FIG. 3 is a partial enlarged view at A in FIG. 1.

FIG. 4 is a perspective view of a valve piece in the gas spring of FIG. 1.

FIG. 5 is a perspective view of a valve piston used in the gas spring of FIG. 1.

FIG. 6 is a perspective view of a rivet used in the gas spring of FIG. 1.

FIG. 7 is a perspective view of a valve body used in the gas spring of FIG. 1.

FIG. 8 is a perspective view of a gasket used in the gas spring of FIG. 1.

As shown in the Figures, reference numerals designate the following components:
Outer steel tube 1,
Inner steel pipe 2, piston 3, hollow piston rod 4, control rod 5, valve pin 6,
Valve body piston 7, mounting groove 7.1, overflow hole 7.2,
Valve body 8, flow channel 8.1, valve body body 8.2, rivet tube body 8.3, rivet end 8.4,
Valve piece 9, notch 9.1, non-notched valve piece 9.2, notched valve piece 9.3,
Valve cavity 10, upper cavity 11, lower cavity 12,
Gasket 13, conical surface 13.1.

### DETAILED DESCRIPTION

In order to make the purpose, technical solutions and advantages of the embodiments of the technical solutions of the present invention clearer, the present invention is further described below in conjunction with the accompanying drawings and specific embodiments.

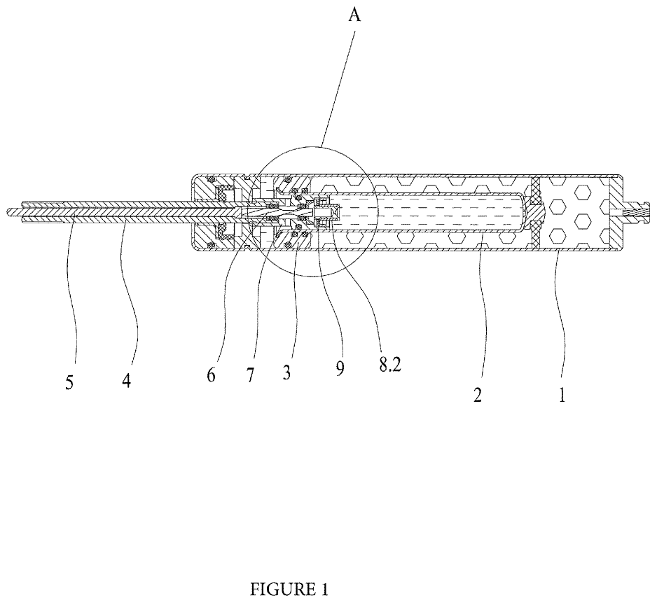

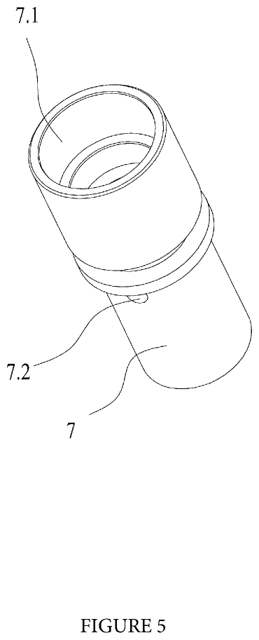

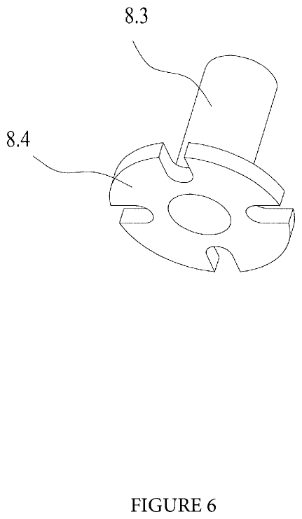

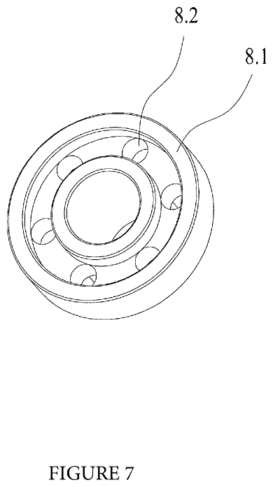

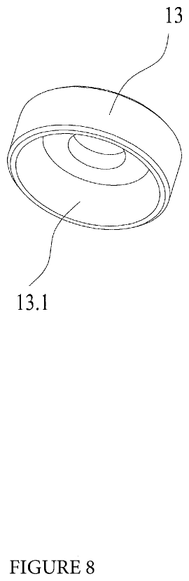

Specific embodiment one, as shown in FIGS. 1 to 8, a kind of extension and compression controllable double-tube gas spring, including: an outer steel tube 1; an inner steel tube 2, the inner steel tube 2 is slidingly provided in the outer steel tube 1 by a piston 3; a hollow piston rod 4, the rear end of the hollow piston rod 4 extends from the front end of the outer steel tube 1 to the inner steel tube 2; a one-way throttle valve, the front end of the one-way throttle valve connects with the hollow piston rod 4. The hollow piston rod 4 is slidingly provided with a control rod 5, the one-way throttle valve is provided with a valve pin 6, the control rod 5 and the valve pin 6 cooperate to control the opening and closing of the one-way throttle valve. The one-way throttle valve and the inner wall of the inner steel tube 2 are sealed and slidingly fitted, and the one-way throttle valve controls throttling when the hollow piston rod 4 is driven to compress gas in a chamber between outer steel tube 1 and inner steel tube 2.

An extension and compression controllable double tube gas spring in the above embodiment, with a gas chamber between the outer steel tube 1 and the inner steel tube 2, and an oil chamber between the one-way throttle valve and the inner steel tube 2, and the control rod 5 adjusts the valve pin 6 to start, realizing the extension and compression of the gas spring; when withdrawing the external force on the control rod 5, the valve pin 6 closes due to the difference between internal and external compression strengths and the outside pressure is less than the internal compression strength, which generates a thrust force to make the valve pin 6 close, and at this time, the oil circuit is closed, and it is more difficult for the oil to be compressed, and the internal compression strength is unchanged, and the hollow piston rod 4 can be maintained at an arbitrary position, and make the hollow piston rod 4 with a higher value of the dead force, and withstand the greater stability, and withstand larger external forces.

The problem of existing gas springs that are prone to jamming, vibration and noise during rapid extension is solved, as well as the problem of lower dead force values and heavier down force in the locked state.

Adopting the double tube structure design of inner steel tube 2 and outer steel tube 1, outer steel tube 1 is used for elastic cushioning and inner steel tube 2 is used for stroke displacement, which makes the friction generated during the gas spring extension process (compression of hollow piston rod 4 after the activation of the valve pin 6) greatly reduced; the gas spring extends slowly, realizing the stroke extension without jamming and vibration, and the slow extension avoids the collision of internal parts of the gas spring to generate noise.

The rear end of the hollow piston rod 4 is connected to a one-way throttle valve, and the one-way throttle valve acts as a throttle in the gas spring extension process, making the gas spring extension slow; the one-way throttle valve does not act as a throttle in the gas spring depressing process, making the gas spring depressing easy. It realizes the performance that the gas spring can be extended slowly and press down easily at the same time.

Specifically, as shown in FIGS. 1, 2, and 3, the one-way throttle valve includes a valve piston 7 and a throttle valve, the throttle valve is provided at a rear end of the valve piston 7, and the valve piston 7 is provided in a sealing and sliding fit with an inner wall of the inner steel tube 2. A sealing ring is provided between the valve piston 7 and the inner wall of the inner steel pipe 2 to provide a sealing effect. The one-way throttle valve slides sealingly within the inner steel tube 2 via the valve piston 7.

Further, as shown in FIGS. 1, 2, 3, and 4, the throttle valve comprises a valve body 8 and a valve disc 9, the valve body 8 being connected to the rear end of the piston 7, the valve disc 9 being socketed to the valve body 8, the valve disc 9 sliding axially along the center axis of the valve body 8, the valve body 8 being provided with a flow channel 8.1, the valve disc 9 being provided with a notch 9.1 at an end toward the flow channel 8.1, the notch 9.1 fitting with the flow channel 8.1. The notch 9.1 cooperates with the flow channel 8.1 to form a throttle port, and the throttle port throttles flow in one direction. The flow channel 8.1 passes through the interior of the inner steel tube 2 and the valve piston 7, and when the valve pin 6 is activated to compress the hollow piston rod 4, the oil in the inner steel tube 2 flows from the throttle valve to the valve piston 7, and the oil squeezes the valve piece 9 toward the front end of the valve body 8, at which time the throttle port opens, and the one-way throttle valve does not have a throttling effect, which makes it easy for the gas spring to be pressed down; and when the valve pin 6 is activated to extend the hollow piston rod 4, the oil in the inner steel tube 2 flows from the valve piston 7 toward the valve body 8, with the throttle port opening. When the valve piston 7 flows to the throttle valve, the oil squeezes the valve piece 9 towards the back end of the valve body 8, the valve piece 9 and the flow channel 8.1 with the formation of throttle port, one-way throttle valve throttle effect, make the gas spring stretch slowly, realize the stroke stretch without jamming, jitter, slow stretching to avoid the collision of internal parts of the gas spring to produce noise.

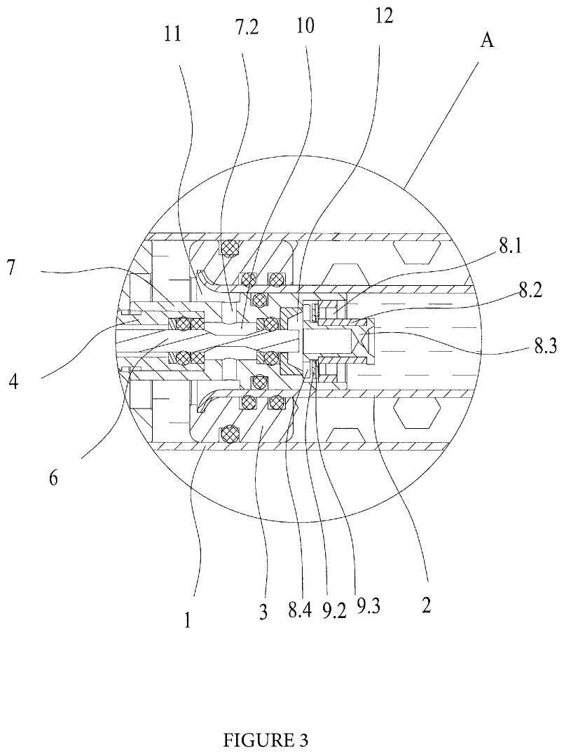

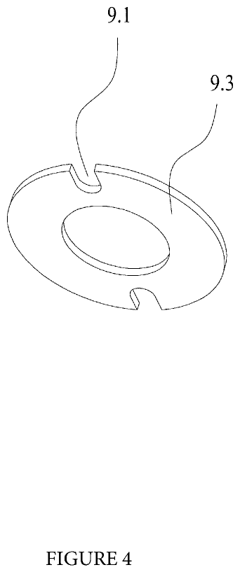

For further optimization of the valve piece 9, as shown in FIGS. 3 and 4, the valve piece 9 comprises a non-notched valve piece 9.2 and a notched valve piece 9.3 slidingly disposed on the valve body 8, the notched valve piece 9.3 is disposed at the rear end of the non-notched valve 9.2, a notch 9.1 is disposed on the notched valve piece 9.3, and the notched valve piece 9.3 and the non-notched valve 9.2 cooperate with the flow path 8.1 of the valve body 8 to form a throttle port. The non-notched valve 9.2, the notched valve piece 9.3 and the valve body 8 are coaxially provided, and the use of the structural design in which the non-notched valve 9.2 and the notched valve piece 9.3 cooperate makes it easy to process the valve piece 9.

In this embodiment, specifically, the valve body 8 comprises an axially through valve body 8.2 and a rivet, the rivet being axially riveted to the valve body 8.2, the rivet comprising a rivet tube body 8.3 with an opening towards the piston 7 of the valve body 8 and a rivet end 8.4 disposed at the front end of the rivet tube body 8.3, the valve piece 9 being socketed to the rivet tube body 8.3, and the rivet end 8.4 restricting the valve piece 9 to the rivet tube body 8.3. The rear end of the valve piston 7 is provided with a mounting groove 7.1, the front end of the valve piston 7 is fixedly mounted in the mounting groove 7.1, and the interior of the inner steel tube 2 is connected to the valve body 8 piston 7 through the flow channel 8.1. A rivet end 8.4 rests against the bottom of the groove of the mounting slot 7.1, and the rivet end 8.4 is provided with an exclusion opening which passes through the interior of the valve body 8 piston 7 and the inner steel tube 2. The rivet is provided with an opening toward the valve body 8 piston 7, and the rivet serves to support the valve body 8.2 and the limit valve piece 9. The number of flow channels 8.1 is a plurality, the runners 8.1 are distributed circumferentially according to the center axis of the valve body 8, the front end of the valve body 8.2 is provided with an annular groove, the annular groove is connected to the flow channels 8.1, the shown annular groove allows the oil to pass through the flow channels 8.1 and then uniformly pass through the throttling holes, and the valve piece 9 is pressurized with a uniform exclusion to prevent the rivet end 8.4 from clogging the rear end of the valve piston 7, and the valve piston 7 throttling valves are connected through the exclusions.

Further, an opening in the rivet tube body 8.3 towards the valve piston 7 is provided coaxially with the valve pin 6, and when the control rod 5 is compressed, the rear end of the valve pin 6 extends into the opening. The opening is used to avoid extension and compression of the valve pin 6.

In this embodiment, as shown in FIG. 3, the valve piston 7 is provided with a valve cavity 10, the valve piston 7 is provided with an overflow hole 7.2 on the sidewall of the valve piston 7, the valve piston 7 is provided with an upper chamber 11 between the valve piston 7 and the front end of the inner steel tube 2, the valve piston 7 is provided with a lower chamber 12 between the valve piston 7 and the throttle valve, the overflow hole 7.2 is connected through the upper chamber 11 and the valve cavity 10, the valve cavity 10 and the lower chamber 12 are connected to each other through the valve pin 6. The valve cavity 10 and the lower cavity 12 are opened and closed by the valve pin 6, and the lower cavity 12 is connected to the interior of the inner steel tube 2. When the hollow piston rod 4 is compressed after the valve pin 6 is activated, the oil inside the inner steel tube 2 passes through the flow channel 8.1, the throttle port, the lower chamber 12, the valve chamber 10, the overflow hole 7.2 and enters the upper chamber 11 in turn; when the hollow piston rod 4 is extended after the valve pin 6 is activated, the oil inside the upper chamber 11 passes through the overflow hole 7.2, the valve chamber 10, the lower chamber 12, the flow channel 8.1 and enters the oil cavity in turn.

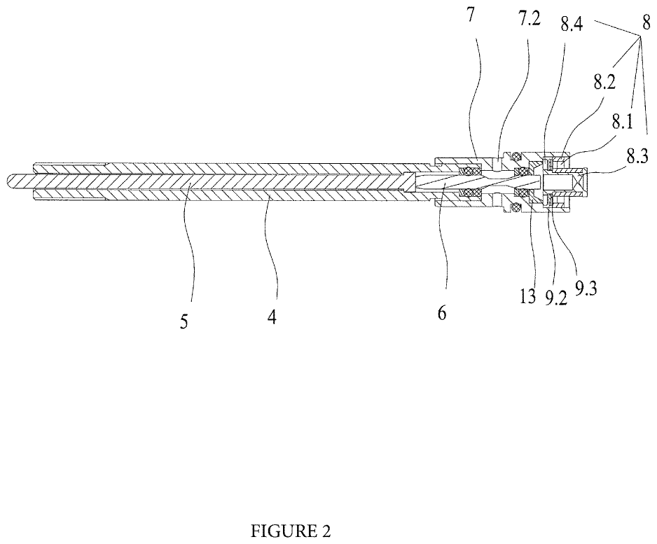

Further, as shown in FIGS. 2, 3, and 8, the valve pin 6 is provided with a seal between the valve pin 6 and the inner wall of the piston 3 valve body 8, the bottom of the groove of the mounting slot 7.1 is provided with a limit groove, and the limit groove is provided with a shim 13, and the shim 13 restricts the seal ring in the valve cavity 10, and the valve pin 6 passes through the shim 13, and the shim 13 has a front-smaller and back-larger tapered surface 13.1 on the inside side wall of the end of the valve toward the throttle valve. the shim 13 is used to limit the limit ring within the valve cavity 10, the shim 13 being seated in the limit slot. The conical surface 13.1 on the gasket 13 cooperates with the valve pin 6 so that there is less cross-sectional change in the oil as it passes through the lower chamber 12, reducing oil turbulence.

The outer steel tube 1 is a cavity structure that is axially coherent in the front and back, the outer steel tube 1 is sealed with a first rear plug at the rear end of the outer steel tube 1, the front opening of the outer steel tube 1 shrinks inwardly to form a blocking surface, the outer steel tube 1 is provided with a sealing guide assembly axially supporting the hollow piston rod 4 at an internal front position, and an air cavity is formed between the outer steel tube 1 and the inner steel tube 2. The inner steel pipe 2 is a cavity structure axially through front and rear, the front end of the inner steel pipe 2 is fixedly connected to the piston 3, the rear end of the inner steel pipe 2 is sealed with a second rear plug, the second rear plug is provided with a guide sleeve, the guide sleeve is slidingly fitted with the inner wall of the outer steel pipe 1, and an oil cavity is formed between the one-way throttle valve and the inner steel pipe 2.

The seal guide assembly includes, in order from front to back, a guide sleeve, an oil seal, and a spacer.

The operation principle of the present invention: when the external force presses the control rod 5, the control rod 5 moves, thus pushing the valve pin 6 to start, thus making the upper chamber 11, the valve chamber 10, the lower chamber 12 connected, and then the external force continues to press the hollow piston rod 4, when the external force is greater than the support force of the hollow piston rod 4, the hollow piston rod 4 continues to be downwardly pressurized, due to the hollow piston rod 4 squeezes the oil in the inner tube 2 inside the oil, so that the oil in the oil cavity is squeezed into the flow channel 8.1, the lower chamber 12, the valve cavity 10 and overflow holes 7.2 flow into the upper chamber 11, and at the same time due to the friction of the reaction force, so that the hollow piston rod 4 drives the inner steel tube 2 to the outer steel tube 1, due to the piston 3 followed by the movement of the inner steel tube 2, which makes the gas cavity gas is compressed, at this time, the throttle port is open to not throttling When the external force is less than the support force of the hollow piston rod 4, the hollow piston rod 4 extends outward, so that the oil in the upper chamber 11 is squeezed into the valve chamber 10 and flows into the oil chamber through the throttle valve, the hollow piston rod 4 extends out of the inner steel tube 2, and at the same time, the pressure of the gas in the gas chamber pushes the piston 3 outwardly, and at this time the throttle valve acts as a throttling effect, so that the gas spring is slow to extend; When the withdrawal of the external force on the control rod 5, the valve pin 6 due to the internal and external pressure is different and the external pressure is less than the internal pressure, thus generating thrust to make the valve pin 6 closed, the valve pin 6 isolates the valve cavity 10 and the lower chamber 12, at this time the oil circuit is closed, the oil is more difficult to compress, the internal pressure remains unchanged, the hollow piston rod 4 can be stayed at any position, and make the locking force of the piston 3 rod is higher, and the stability is good.

The present invention has the following beneficial effects: the hollow piston rod 4 can stay in any position, the hollow piston rod 4 has a higher dead force value, better stability, and can withstand a larger external force; the use of inner steel tube 2 and outer steel tube 1 of the double tube structure design, the outer steel tube 1 is used for elasticity cushioning, the inner steel tube 2 is used for the stroke displacement, so that the friction generated in the process of gas spring extension is greatly reduced; the gas spring extension Slowly, to achieve the stroke extension without jamming, jitter, slow extension to avoid collision of internal parts of the gas spring noise; hollow piston rod 4 is connected to the rear end of the one-way throttle valve, the gas spring extension process one-way throttle valve play a role in throttling, so that the gas spring extension is slow; gas spring down in the process of one-way throttle valve does not play a role in throttling, so that the gas spring down easy to realize the gas spring extension is slow at the same time, but also to achieve the performance of the downward pressure. The performance of slow extension of the gas spring can be realized at the same time to achieve the performance of easy downward pressure.

The specific embodiments described above are only preferred embodiments of the present invention, and are not intended to limit the scope of the present invention. Any equivalent changes made in accordance with the shape and structure of the present invention should be included in the scope of protection of the present invention.

The above-mentioned are merely specific embodiments of the present disclosure, but the scope of protection of the present disclosure is not limited thereto, and variations or substitutions, that can be readily envisaged by any technician familiar with the present technical field within the technical scope disclosed in the present disclosure, shall be covered in the scope of protection of the present disclosure. Therefore, the scope of protection of the present disclosure should be determined by the scope of protection of the claims.

1. An extractable double-tube gas spring, comprising:
an outer steel tube;
an inner steel tube, the inner steel tube being placed within the outer steel tube by a piston;
a hollow piston rod, the rear end of the hollow piston rod extending from the front end of the outer steel tube into the inner steel tube;
a one-way throttle valve, the front end of the one-way throttle valve is connected to the hollow piston rod, said hollow piston rod is slidingly placed with a control rod, said one-way throttle valve is placed with a valve pin, said control rod and valve pin work together to control the opening and closing of the one-way throttle valve, said one-way throttle valve is sealing and slidingly mating with the inner wall of the inner steel pipe, and the one-way throttle valve controls throttling when the hollow piston rod is compressed.

2. An extractable double-tube gas spring according to claim 1, wherein the one-way throttling valve comprises a valve piston and a throttling valve, said throttling valve being placed at the rear end of said valve piston, and said valve piston being sealed and slidingly fitted to the inner wall of the inner steel tube.

3. An extractable double-tube gas spring according to claim 1, wherein the throttle valve comprises a valve body and a valve plate, said valve body being connected to the rear end of a valve piston, said valve plate being socketed to the valve body, said valve plate sliding axially along the center axis of the valve body, said valve body being placed with a flow channel, said valve plate being placed with a notch at an end facing the flow channel, said notch mating with said flow channel to form a throttling port notch mating with said flow channel to form a throttle port, said throttle port throttling flow in one direction.

4. An extractable double-tube gas spring according to claim 1, wherein the valve piece comprises a unnotched valve piece and a notched valve piece slidably socketed on the valve body, said unnotched valve piece being located at the rear end of the unnotched valve piece, said notch being located on the unnotched valve piece, and said unnotched and notched valves mating to form a throttling port with the flow path of the valve body.

5. An extractable double-tube gas spring according to claim 1, wherein the valve body comprises an axially penetrating valve body and a rivet, said rivet being axially riveted to the valve body, said rivet comprising a rivet tube body with an opening towards the valve body piston, and a rivet end set at the front end of the rivet tube body, said valve piece being socketed to the rivet tube body, said rivet end restricts the valve piece to the rivet tube body.

6. An extractable double-tube gas spring according to claim 1, wherein the rear end of said valve piston is placed with a mounting groove, the front end of said valve piston is fixedly mounted in said mounting groove, and the inside of said inner steel tube communicates with the valve piston by means of a flow channel.

7. An extractable double-tube gas spring according to claim 1, wherein the rivet end rests against the bottom of the groove of the mounting groove, said rivet end being placed with an opening, said opening passing through the interior of the valve piston and the inner steel tube.

8. An extractable double-tube gas spring according to claim 1, wherein an opening in said rivet tube body towards the valve piston is coaxially placed with a valve needle, and the rear end of the valve pin extends into said opening when the control rod is compressed.

9. An extractable double-tube gas spring according to claim 1, wherein the valve piston is placed with a valve chamber, said valve piston is placed with an overflow hole on the side wall, said valve piston is placed with an upper chamber between said valve piston and the front end of the inner steel tube, and said valve piston is placed with a lower chamber between said valve piston and a throttling valve, and said overflow hole is connected through the upper and the valve chambers, and said valve cavity and the lower cavity are opened and closed by means of a valve pin, said lower cavity being connected to the interior of the inner steel tube.

10. An extractable double-tube gas spring according to claim 1, wherein the valve pin is placed with a sealing ring between said valve pin and the inner wall of the piston valve body, the bottom of said groove of said mounting groove is placed with a limiting groove, and said limiting groove is placed with a gasket, said gasket limiting the sealing ring in the valve cavity, said valve pin passes through said gasket, and said gasket has a conical surface with a small front and a large back on the inner side wall of said gasket towards one end of the throttle valve surface.

11. A gas spring comprising:
an outer steel tube having a front end and a rear end;
an inner steel tube positioned within the outer steel tube, the inner steel tube having a front end and a rear end;
a piston affixed to the front end of the inner tube and located between the inner steel tube and the outer steel tube to allow compression of a gas contained in a gas cavity defined between the inner steel tube and the outer steel tube;
a hollow piston rod having a front end distal of the inner steel tube and an opposite rear end;
a one-way throttle valve connected to the rear end of the hollow piston rod;
a control rod slidable in the hollow piston rod; and
a valve pin engaged by the control rod to control opening and closing of the one-way throttle valve.

12. The gas spring of claim 11, wherein the throttle valve comprises a valve piston, a valve body defining a flow channel, and a notched valve disc having a notch that cooperates with the flow channel to throttle flow in one direction.

13. The gas spring of claim 11, wherein the throttle valve further comprises a non-notched valve disc located adjacent the notched valve disc.

14. The gas spring of claim 12, wherein the valve body includes a rivet axially riveted to the valve body, the rivet restricting the notched valve disc to the rivet tube body.

15. The gas spring of claim 12, wherein the valve piston has a mounting groove receiving the valve body, and wherein the valve body defines a flow channel from an oil cavity defined by the interior of the inner tube to the throttle valve.
